(19) United States
(12) Patent Application Publication
(10) Pub. No.: US 2012/0114125 A1
(43) Pub. Date: May 10, 2012

(54) AUDIO SIGNAL PROCESSING DEVICES HAVING POWER SIGNAL DECODING CIRCUITS THEREIN

(76) Inventors: Dupanda Xue, Shanghai (CN); Xin Liu, Shanghai (CN)

(21) Appl. No.: 12/942,651

(22) Filed: Nov. 9, 2010

(51) Int. Cl. H04R 5/00

(52) U.S. Cl. 381/17

(57) ABSTRACT

An audio signal receiver includes left and right audio ports that are configured to receive left and right audio signals, respectively. The audio signal receiver also includes a power signal decoding circuit that is configured to extract a DC voltage from at least one of the left and right audio signals. Furthermore, the audio signal receiver includes an audio signal processor that is responsive to the left and right audio signals, and the audio signal processor is powered by the extracted DC voltage.

### FIELD OF THE INVENTION

The present invention relates generally to electronic devices and, more particularly, to electronic devices that process audio signals.

### BACKGROUND OF THE INVENTION

Many electronic devices that receive audio signals from other electronic devices require a separate supply of power from sources such as batteries or power adapters. For example, electronic devices that receive audio signals from other electronic devices require may separately require power from batteries, an AC wall adapter, or a car adapter. Such sources of power may be bulky, heavy, expensive, and/or energy inefficient.

### SUMMARY OF THE INVENTION

Some embodiments of the present invention include an audio signal receiver that includes left and right audio ports configured to receive left and right audio signals, respectively. According to some embodiments, the audio signal receiver may include a power signal decoding circuit configured to extract a DC voltage from at least one of the left and right audio signals. According to further aspects of these embodiments, the audio signal receiver may include an audio signal processor responsive to the left and right audio signals. The audio signal processor may be powered by the extracted DC voltage.

In some embodiments, the power signal decoding circuit includes a low pass filter having an input electrically coupled to one of the left and right audio ports.

In some embodiments, the power signal decoding circuit further includes a voltage regulator having an input electrically coupled to an output of the low pass filter.

In some embodiments, the power signal decoding circuit further includes a band pass filter having an input electrically coupled to one of the left and right audio ports.

In some embodiments, the power signal decoding circuit further includes a band pass filter having an input electrically coupled to one of the left and right audio ports and an output electrically coupled to the audio signal processor.

In some embodiments, the band pass filter includes a multistage high pass filter network and a multistage low pass filter network with gain compensation, connected in series.

In some embodiments, the audio signal processor is powered by a voltage generated at an output of the voltage regulator.

In some embodiments, the left and right audio ports are electrically coupled to a male stereo audio jack.

In some embodiments, an audio signal processing system includes a host electronic device including a power supply, the host electronic device configured to supply a DC voltage generated by the power supply. According to some embodiments, the audio signal processing system may include a receiver including left and right audio ports configured to receive left and right audio signals, respectively, from the host electronic device, the receiver including a power signal decoding circuit configured to extract the DC voltage from at least one of the left and right audio signals, and the receiver including an audio signal processor responsive to the left and right audio signals, the audio signal processor powered by the extracted DC voltage.

In some embodiments, the power supply is configured to add the DC voltage to at least one of the left and right audio signals.

In some embodiments, the host electronic device includes a switch that controls whether the power supply adds the DC voltage to at least one of the left and right audio signals.

In some embodiments, the host electronic device includes a current protector that is between the power supply and at least one of the left and right audio signals.

In some embodiments, the receiver is removable from the host electronic device.

### BRIEF DESCRIPTION OF THE DRAWINGS

FIG. 1 is a block diagram of an audio signal receiver according to some embodiments of the present invention.

FIG. 2 is a block diagram of a multi-stage audio filter that may be used in the audio signal receiver of FIG. 1 according to some embodiments of the present invention.

FIG. 3 is a block diagram of an audio signal receiver according to further embodiments of the present invention.

FIG. 4 is a diagram of a 4-combo audio jack according to some embodiments of the present invention.

### DETAILED DESCRIPTION OF EMBODIMENTS

The present invention now will be described more fully herein with reference to the accompanying drawings, in which various embodiments of the invention are shown. This invention may, however, be embodied in many different forms and should not be construed as being limited to the embodiments set forth herein. Rather, these embodiments are provided so that this disclosure will be thorough and complete, and will fully convey the scope of the invention to those skilled in the art. Like reference numerals refer to like elements throughout and signal lines and signals thereon may be referred to by the same reference characters.

It will be understood that when an element or layer is referred to as being “on,” “connected to,” or “coupled to” another element or layer (and variants thereof), it can be directly on, connected, or coupled to the other element or layer, or intervening elements or layers may be present. In contrast, when an element is referred to as being “directly on,” “directly connected to,” or “directly coupled to” another element or layer (and variants thereof), there are no intervening elements or layers present. As used herein, the term “and/or” includes any and all combinations of one or more of the associated listed items and may be abbreviated as “/.”

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “comprising,” “including,” “having,” and variants thereof, when used in this specification, specify the presence of stated features, steps, operations, elements, and/or components, but do not preclude the presence or addition of one or more other features, steps, operations, elements, components, and/or groups thereof. In contrast, the term “consisting of” when used in this specification, specifies the stated features, steps, operations, elements, and/or components, and precludes additional features, steps, operations, elements, and/or components.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments of the present invention arise from the realization that many electronic devices that receive audio signals from other electronic devices require a separate supply of power from sources such as batteries or power adapters. By way of example, a FM audio dongle kit for transmitting audio signals over FM frequencies may require power from batteries, an AC wall adapter, or a car adapter. Such sources of power may be bulky, heavy, expensive, and/or energy inefficient. Some embodiments described herein, however, include an audio signal device that is powered by a DC voltage extracted from a received audio signal. Further embodiments described herein include an audio signal device that is powered by a DC voltage received through a microphone segment of an audio jack.

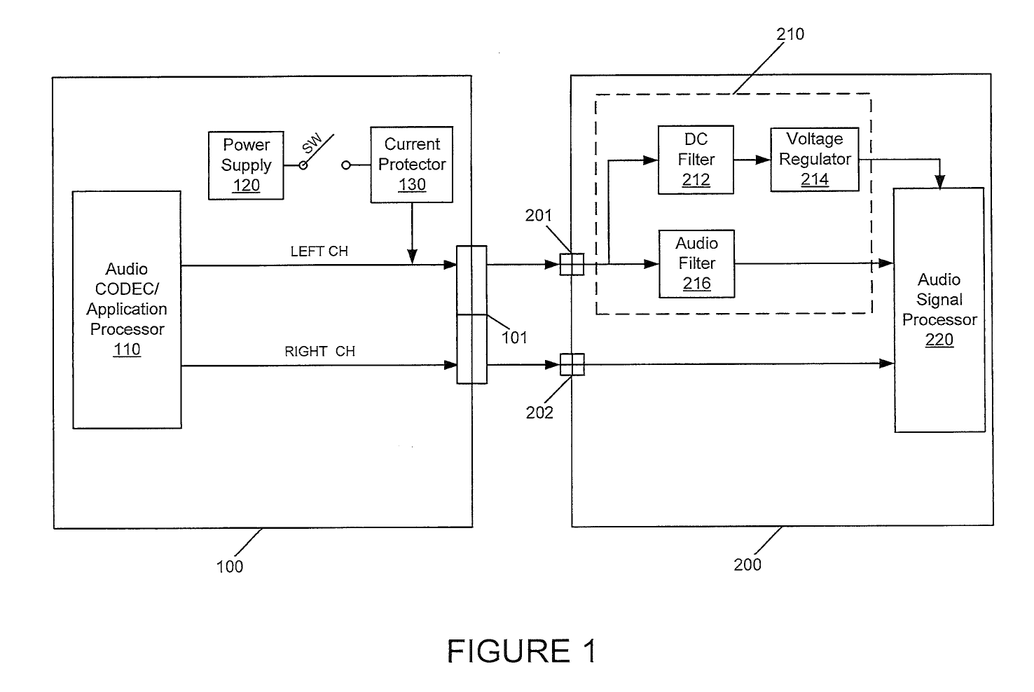

Reference is now made to FIG. 1, which is a block diagram of an audio signal receiver 200 that includes a left audio port 201 and a right audio port 202. The left audio port 201 is configured to receive left audio signals and the right audio port 202 is configured to receive right audio signals. The left audio signals may be audio signals received over a left channel LEFT CH of a stereo audio transmission, and the right audio signals may be audio signals received over a right channel RIGHT CH of the audio transmission. For example, the audio transmission may be from an audio CODEC/application processor 110 of a host electronic device 100. The left audio port 201 and the right audio port 202 may be electrically coupled to a male audio jack, such as a 2.5 mm or 3.5 mm male stereo audio jack.

The host electronic device 100 includes an audio port 101 that may be configured to transmit audio signals. In particular, the audio port 101 of the host electronic device 100 may be configured to transmit the left and right audio signals to the audio signal receiver 200. The audio port 101 may be an audio jack port, such as a 2.5 mm or 3.5 mm audio jack port. Accordingly, the left audio port 201 and the right audio port 202 of the audio signal receiver 200 may be electrically coupled to a male audio jack that may be configured to connect to the audio port 101 of the host electronic device 100. Examples of host electronic devices 100 include such devices as desktop personal computers, notebook computers, netbook computers, mobile phones, MP3/MP4 players, CD/DVD players, TVs, game consoles, mobile Internet devices (MIDs), navigation devices, and the like. Examples of audio signal receivers 200 include external devices such as headphones, speakers, power-sourcing devices, and audio dongles, including FM audio dongles and Bluetooth audio dongles.

A voltage in the host electronic device 100 may be modulated in the left channel LEFT CH or the right channel RIGHT CH. For example, FIG. 1 illustrates a power supply 120 that may be connected to the left channel LEFT CH, but the power supply 120 may alternatively be configured to connect to the right channel RIGHT CH. The power supply 120 may thus add a DC voltage to the left channel LEFT CH or the right channel RIGHT CH. Examples of DC voltages added from the power supply 120 include 2.5V, 3.3V, 3.7V, and the like.

A current protector 130 may be included in the host electronic device 100 to protect the host electronic device 100 from a current surge or short circuit in the audio signal receiver 200. For example, the current protector 130 may be a 200 mA current protector 130. The current protector 130 may be connected between the power supply 120 and the left channel LEFT CH or the right channel RIGHT CH.

A switch SW may enable and/or disable the power supply 120. For example, if the audio signal receiver 200 is connected to the host electronic device 100, such as when a male audio jack of the audio signal receiver 200 is inserted into the audio port 101 of the electronic host device 100, the power supply 120 may be enabled by the switch SW. On the other hand, if the audio signal receiver 200 is not connected to the host electronic device 100, the switch SW may disable the connection between the power supply 120 and the left channel LEFT CH or the right channel RIGHT CH. For example, the switch SW may be off/open when an electronic device that is not configured to receive power from the power supply 120, including some conventional headphones, is connected to the host electronic device 100. The switch SW may be, for example, a software switch and/or an I/O switch. In some embodiments, a user of the host electronic device 100 may turn the switch SW on/closed and/or off/open via a graphical user interface (GUI) of the host electronic device 100.

The audio signal receiver 200 includes a power signal decoding circuit 210 and an audio signal processor 220. The audio signal processor 220 may be configured to respond to the left audio signal and/or the right audio signal. The power signal decoding circuit 210 may be configured to extract a DC voltage from at least one of the left audio signal received via the left audio port 201 and the right audio signal received via the right audio port 202. In particular, the power signal decoding circuit 210 includes a DC filter 212 that may be configured to extract the DC voltage from the left audio signal or the right audio signal. The DC filter 212 may have an input that is electrically coupled to one of the left audio port 201 and the right audio port 202. Additionally, the DC filter 212 may be a low pass filter. Accordingly, the DC filter 212 may pass the extracted DC voltage and block audio data from the left audio signal and/or the right audio signal.

The audio signal receiver 200 may be powered by the extracted DC voltage. For example, the extracted DC voltage may be, or may be derived from, the voltage added to the left channel LEFT CH or the right channel RIGHT CH by the power supply 120 and may be used to power the audio signal processor 220 and/or other portions of the audio signal receiver 200.

The power signal decoding circuit 210 may also include a voltage regulator 214. The voltage regulator 214 may have an input that is electrically coupled to an output of the DC filter 212. Accordingly, the voltage regulator 214 may be connected between the DC filter 212 and the audio signal processor 220. The audio signal processor 220 may be powered by a voltage generated at an output of the voltage regulator 214. Additionally, the voltage generated at an output of the voltage regulator 214 may be different from the extracted DC voltage.

The power signal decoding circuit 210 may further include an audio filter 216. The audio filter 216 may include a bandpass filter having an input that is electrically coupled to one of the left audio port 201 and the right audio port 202. The bandpass filter may further include an output that is electrically coupled to the audio signal processor 220. The bandpass filter may block the DC voltage added by the power supply 120. The bandpass filter may also block noise in the left audio signal and/or the right audio signal. Accordingly, the bandpass filter of the audio filter 216 may be configured to demodulate audio data from the left or right audio signals received by the power signal decoding circuit 210 and to provide the demodulated audio data signal(s) to the audio signal processor 220.

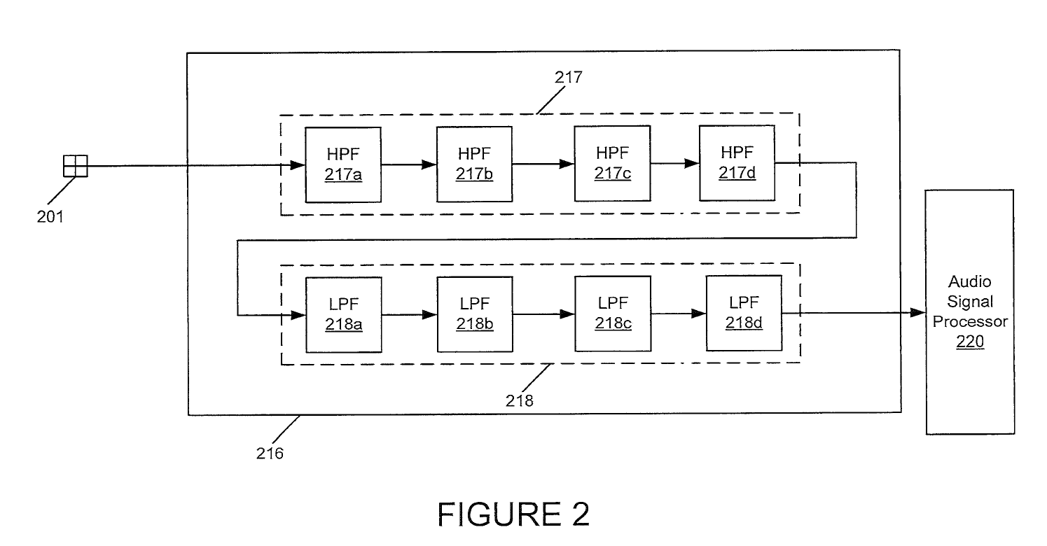

Reference is now made to FIG. 2, which is a block diagram of a multi-stage audio filter according to some embodiments of the power signal decoding circuit 210 of the audio signal receiver 200 illustrated in FIG. 1. For example, the audio filter 216 may include a bandpass filter that may include a multi-stage high pass filter network 217 and a multi-stage low pass filter network 218. The multi-stage low pass filter network 218 may include gain compensation. The multi-stage high pass filter network 217 and the multi-stage low pass filter network 218 may be connected in series. For example, the multi-stage high pass filter network 217 may include an output that is electrically coupled to an input of the multi-stage low pass filter network 218. The multi-stage high pass filter network 217 may include an input that is electrically coupled to one of the left audio port 201 and the right audio port 202. Additionally, the multi-stage low pass filter network 218 may include an output that is electrically coupled to the audio signal processor 220.

The multi-stage high pass filter network 217 may include a plurality of high pass filters. Additionally, the multi-stage low pass filter network 218 may include a plurality of low pass filters. For example, although FIG. 2 illustrates four high pass filters 217a-d and four low pass filters 218a-d, the multi-stage high pass filter network 217 and/or the multi-stage low pass filter network 218 may include more than or fewer than four filters.

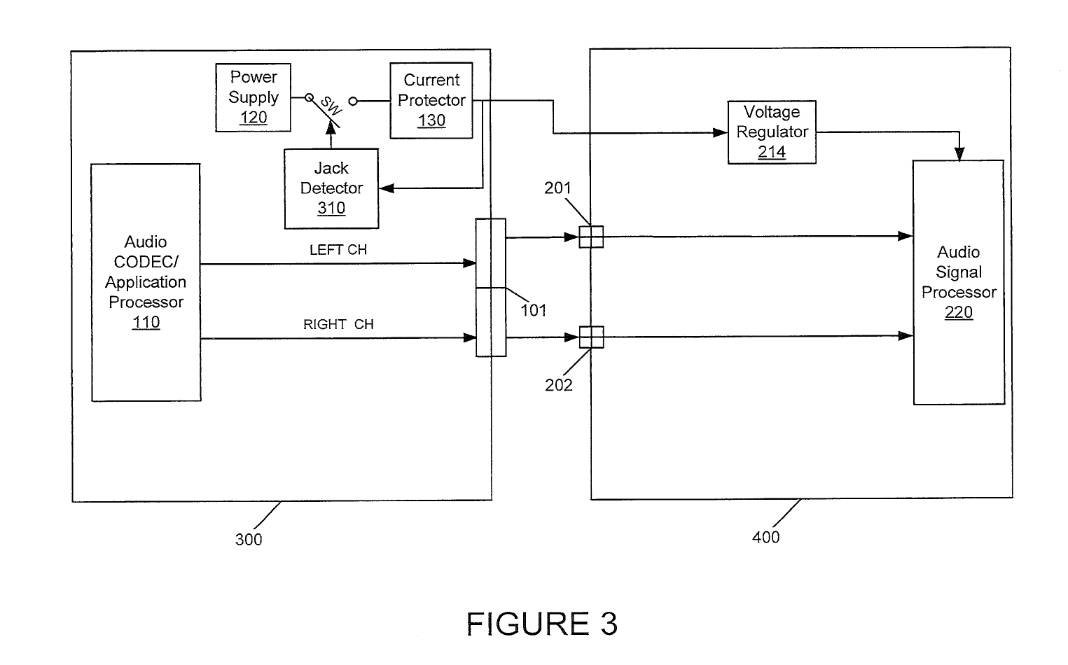

Reference is now made to FIG. 3, which is a block diagram of an audio signal receiver 400 according to further embodiments of the present invention. The audio signal receiver 400 includes the left audio port 201 and the right audio port 202 illustrated in FIG. 1. The audio signal receiver 400 also may include the audio signal processor 220 illustrated in FIG. 1. The audio signal processor 220 may have an input that is electrically coupled to the left audio port 201 and the right audio port 202. The audio signal receiver 400 may further include the voltage regulator 214 illustrated in FIG. 1.

A host electronic device 300 may include the current protector 130 illustrated in FIG. 1. The voltage regulator 214 may have an input that is electrically coupled to the current protector 130.

The host electronic device 300 may further include a jack detector 310. The jack detector 310 may detect whether an audio jack is inserted into the audio port 101 of the host electronic device 300 and provide compatibility with a plurality of audio jack insertion possibilities for the audio port 101, including 4-combo audio jacks, 3-combo audio jacks, headset insertion, and the absence of jack insertion. The jack detector 310 may have an input that is electrically coupled to the current protector 130. The switch SW may be controlled by the jack detector 310. In particular, the jack detector 310 may determine whether the power supply 120 provides a voltage to the current protector 130.

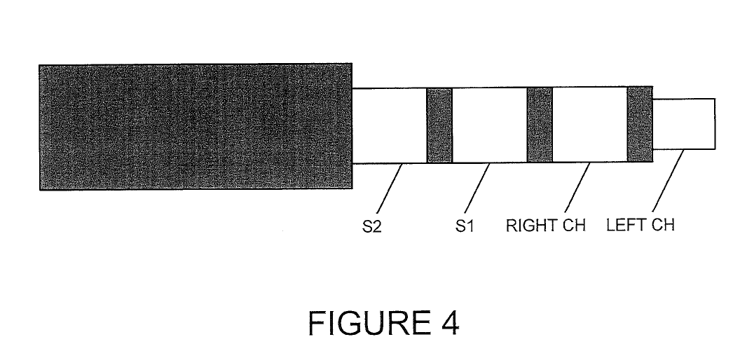

Reference is now made to FIG. 4, which is a diagram of a 4-combo audio jack according to some embodiments of the present invention. The left audio port 201 and the right audio port 202 of the audio signal receiver 400 may be electrically coupled to the 4-combo audio jack, which may be a male audio jack. The left audio signals from the host electronic device 300 may be received over a left channel LEFT CH segment of the 4-combo audio jack, and the right audio signals from the host electronic device 300 may be received over a right channel RIGHT CH segment of the 4-combo audio jack. An S1 segment of the 4-combo audio jack may be electrically coupled to ground. An S2 segment of the 4-combo audio jack may be a microphone segment of the 4-combo audio jack.

The host electronic device 300 may provide a DC voltage to the S2 segment of the 4-combo audio jack. In particular, the power supply 120 may provide a DC voltage such as 2.5V, 3.3V, 3.7V, and the like. The audio signal receiver 400 may receive the DC voltage via the S2 segment of the 4-combo audio jack and the voltage regulator 214. The audio signal processor 220 may be powered by a voltage generated at an output of the voltage regulator 214. Additionally, the voltage generated at the output of the voltage regulator 214 may be different from the DC voltage of the S2 segment of the 4-combo audio jack.

The jack detector 310 may control the switch SW to provide the DC voltage from the power supply 120 to the S2 segment of the 4-combo audio jack based on whether the jack detector 310 determines that the 4-combo audio jack is actually a 4-combo audio jack, as opposed to a 3-combo audio jack or no audio jack at all. For example, if the 4-combo audio jack is inserted into the audio port 101, then the jack detector 310 may be configured to detect the 4-combo audio jack and control the switch SW to add the DC voltage from the power supply 120. In contrast, if the jack detector 310 determines that a 3-combo audio jack is inserted into the audio port 101 or that no audio jack is inserted into the audio port 101, the jack detector 310 may control the switch SW to prevent power from the power supply 120 from flowing to the audio jack detected in the audio port 101.

The jack detector 310 may also detect whether the S2 segment of the 4-combo audio jack is idle and determine how to control the power supply 120 based on whether the S2 segment is idle. For example, some audio dongle applications, such as Bluetooth audio dongles and FM audio dongles, may have an idle S2 segment. Thus, the jack detector 310 may control the switch SW to supply power from the power supply 120 in response to a determination that the S2 segment of the 4-combo audio jack is idle. Accordingly, the audio signal receiver 400 may receive power from the host electronic device 300 via the S2 segment of the 4-combo audio jack, thus obviating the need to power the audio signal receiver 400 from sources such as batteries and power adapters.

Although the present invention has been particularly shown and described with reference to embodiments thereof, it will be understood by those of ordinary skill in the art that various changes in form and details may be made therein without departing from the spirit and scope of the present invention as defined by the following claims.

That which is claimed is:

1. An audio signal receiver, comprising:
left and right audio ports configured to receive left and right audio signals, respectively;
a power signal decoding circuit configured to extract a DC voltage from at least one of said left and right audio signals; and
an audio signal processor responsive to said left and right audio signals, said audio signal processor powered by the extracted DC voltage.

2. The receiver of claim 1, wherein said power signal decoding circuit comprises a low pass filter having an input electrically coupled to one of said left and right audio ports.

3. The receiver of claim 2, wherein said power signal decoding circuit further comprises a voltage regulator having an input electrically coupled to an output of the low pass filter.

4. The receiver of claim 3, wherein said power signal decoding circuit further comprises a band pass filter having an input electrically coupled to one of said left and right audio ports.

5. The receiver of claim 1, wherein said power signal decoding circuit further comprises a band pass filter having an input electrically coupled to one of said left and right audio ports and an output electrically coupled to said audio signal processor.

6. The receiver of claim 5, wherein the band pass filter comprises a multistage high pass filter network and a multistage low pass filter network with gain compensation, connected in series.

7. The receiver of claim 3, wherein said audio signal processor is powered by a voltage generated at an output of the voltage regulator.

8. The receiver of claim 1, wherein said left and right audio ports are electrically coupled to a male stereo audio jack.

9. An audio signal receiver, comprising:
left and right audio ports configured to receive left and right audio signals, respectively;
a power signal decoding circuit configured to extract a DC voltage from at least one of said left and right audio signals, said power signal decoding circuit comprising a low pass filter having an input electrically coupled to one of said left and right audio ports; and
an audio signal processor responsive to said left and right audio signals, said audio signal processor powered by the extracted DC voltage, and said power signal decoding circuit further comprising a band pass filter having an input electrically coupled to one of said left and right audio ports and an output electrically coupled to said audio signal processor.

10. An audio signal processing system, comprising:
a host electronic device including a power supply, said host electronic device configured to supply a DC voltage generated by said power supply; and
a receiver including left and right audio ports configured to receive left and right audio signals, respectively, from said host electronic device, said receiver including a power signal decoding circuit configured to extract the DC voltage from at least one of said left and right audio signals, and said receiver including an audio signal processor responsive to said left and right audio signals, said audio signal processor powered by the extracted DC voltage.

11. The system of claim 10, wherein said power supply is configured to add the DC voltage to at least one of said left and right audio signals.

12. The system of claim 11, wherein said host electronic device includes a switch that controls whether said power supply adds the DC voltage to at least one of said left and right audio signals.

13. The system of claim 11, wherein said host electronic device includes a current protector between said power supply and at least one of said left and right audio signals.

14. The system of claim 10, wherein said receiver is removable from said host electronic device.
